(19) United States
(12) Patent Application Publication
(10) Pub. No.: US 2025/0225513 A1
(43) Pub. Date: Jul. 10, 2025

(54) SYSTEMS AND METHODS FOR VALIDATING TRANSACTIONS

(71) Applicant: Capital One Services, LLC, McLean, VA (US)

(72) Inventors: Kevin OSBORN, Newton Highlands, MA (US); Srinivasa CHIGURUPATI, Long Grove, IL (US); John JONES, Leesburg, VA (US)

(21) Appl. No.: 18/407,937

(22) Filed: Jan. 9, 2024

(51) Int. Cl. G06Q 20/40; G06Q 20/38

(52) U.S. Cl. CPC G06Q 20/401; G06Q 20/3825; G06Q 20/3827; G06Q 20/3829; G06Q 2220/00

(57) ABSTRACT

Systems and methods of validating transactions are provided. An exemplary system includes a server including a memory and a processor. The server is configured to: receive from an entity a transaction validation request of validating a transaction; validate the transaction; generate a logging record of the transaction validation; cryptographically hash the logging record to create a hashed logging record; digitally sign the hashed logging record using a key to create a signed hashed logging record; and transmit the signed hashed logging record to a computer device.

### FIELD OF THE INVENTION

The present disclosure relates generally to transaction validation, and more particularly, to systems and methods for validating transactions.

### BACKGROUND

In transaction validations, transaction validations provided by a service that is run in a third party's computing environment are required to be reliably metered for service billing purposes. Different third entities can be running validation services, and it is desirable to be able to actually collect login information that can be useful to monitor the usage of the service for both billing purposes and monitoring of operational status. The operational status, for example, can include whether the service is being turned off, whether a transaction is being routed to a different place, and so forth.

Accordingly, there is a need to provide systems and methods that can manage the usage of the transaction validation service for billing purposes and to ensure that users are in compliance and consistent with the terms of service.

### SUMMARY

Aspects of the disclosed technology include systems and methods of validating transactions.

Embodiments of the present disclosure provide a system of validating transactions. The system can include a server including a memory and a processor. The server can be configured to: receive from an entity a transaction validation request of validating a transaction; validate the transaction; generate a logging record of the transaction validation; cryptographically hash the logging record to create a hashed logging record; digitally sign the hashed logging record using a key to create a signed hashed logging record; and transmit the signed hashed logging record to a computer device.

Embodiments of the present disclosure provide a method of validating transactions performed by a server. The method can include: receiving from an entity a transaction validation request of validating a transaction; validating the transaction; generating a logging record of the transaction validation; cryptographically hashing the logging record to create a hashed logging record; digitally signing the hashed logging record using a key to create a signed hashed logging record; and transmitting the signed hashed logging record to a computer device.

Embodiments of the present disclosure provide a non-transitory, computer-readable medium comprising instructions for validating transactions that, when executed on a computer arrangement, cause the computer arrangement to perform actions including: receiving from an entity a transaction validation request of validating a transaction; validating the transaction; generating a logging record of the transaction validation; cryptographically hashing the logging record to create a hashed logging record; digitally signing the hashed logging record using a key to create a signed hashed logging record; and transmitting the signed hashed logging record to a computer device.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

FIG. 1 is a diagram of a system of transaction validation according to an example embodiment.

FIG. 2 is a diagram of sequential interactions between components of the system in FIG. 1 according to an example embodiment.

FIG. 3 is a flow chart of a method of transaction validation according to an example embodiment.

FIG. 4 is a flow chart of a method of transaction validation according to an example embodiment.

FIG. 5 is a flow chart of a method of transaction validation according to an example embodiment.

FIG. 6 illustrates an exemplary logging record generated during transaction validation according to an example embodiment.

### DETAILED DESCRIPTION OF EXAMPLE EMBODIMENTS

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The described features and teachings of the embodiments may be combined in any suitable manner. A person of ordinary skill in the art will recognize that the embodiments may be practiced without one or more of the specific features and teachings of an embodiment. In other instances, additional features and teachings may be recognized in certain embodiments that may not be present in all embodiments. A person of ordinary skill in the art will understand that the described features and teachings of any embodiment can be interchangeably combined with the features and teachings of any other embodiment.

In some embodiments, transaction validation can be deployed as a black box service. Embedded in the service can be a creation of logging records which can be delivered in real time, or batch later either through File logging, or messaging service. Each usage of the transaction validation service can be logged and a cryptographic secure hash can be created for each logging record. That hash can be signed by a key accessible to the service (e.g. the key is managed by a hardware security module (HSM) which the client's server has access to for performing cryptographic functions, but not able to access the keys directly.)

In some embodiments, the hash can be signed with a public key embedded and obfuscated in the code. The transaction validation service can be designed as services which can be licensed. on a per use fee basis. In order to do this, a reliable, secure and not intrusive mechanism can be used. The present disclosure discloses herein a logging mechanism with special cryptographic hashes on each logging record to detect tampering. Each logging record can contain a monotonically increasing sequence number, which can be used to detect missing sequence calls (e.g. trying to cheat by removing usage calls.) This can further be improved by including a hash of hashes of the previous logging records up to that point.

In some embodiments, the transaction validation service can be decoupled from other infrastructure, so that the transaction validation service can operate and report back, occasionally that it is up and running but not have to necessarily phone home to prove that it is operating.

The reporting or delivery mechanism of the hashed logging records can be flexible., for example, it can be done in a streaming matter. The hashed logging records can be reported directly or they can be delivered in batches of records. Whatever that delivery mechanism is, the actual mode of compiling those logging records has integrity and that integrity is assembled by creating a chain of hashes, so that each hashed logging record is a hash of the current record plus the previous record, which includes the previous record's hash.

In some embodiments, the hashed logging record is signed with a key. This digital signature can allow to verify that the logging record is untampered with and that the logging record is produced by the transaction validation service.

In some embodiments, a heartbeat pattern message can be included in the hashed logging record to detect the anomaly of the transaction validation service. For the heartbeat pattern message, at a regular interval, a message would be produced whether or not any transaction validation had occurred. This can allow monitoring for the up time of the transaction validation service, as opposed to just how many transaction validations had occurred. For example, if transaction validations are redirected or the transaction validation service is turned off, that can be detected by looking at the frequency of these heartbeat messages. If there have an anomaly or a gap in the heartbeat messages, and they are not at the regular interval, then the transaction validation service can be detected to have been down for some time. The heartbeat messages are non-transactional heartbeat records that can be a part of the immutable hash-tree record. This way it can detect if transaction validations were just skipped, or if the server on which the transaction validation service is deployed is continuously active. This heartbeat message can also include a monotonically increasing counter plus a timecode. This heartbeat message can be a record that is intrinsic to the transaction validation system itself and is not tied to a specific transaction and contains a timestamp. The heartbeat message occurs at a regular interval. The regular interval can be defined inside the heartbeat record itself or it can be something that is understood externally and implicit in the heartbeat record. For example, the interval can be operationally significant time frames, such as short enough to not represent a significant loss of traffic and long enough to not produce too much data.

The logging record may refer to transactional records. The transaction record can include a particular action or event that was called on the server of the transaction validation service. It can include an event identification (ID), the type of event that happened, and any kind of metadata with that event. The event ID may indicate what type of event occurred, for example, a key validation has occurred. There may have metadata that is associated with that event, which can provide details about that event. Those details can include the details of the transaction itself. The metadata may also include which card issuer is using the transaction validation service.

In some embodiment, the event ID can be a snowflake ID. The snowflake ID is a way to generate a unique ID that is full ordered from a timestamp point but unique enough. That snowflake ID is generated by parallel systems that are not duplicated. Through the timestamp, event details can be obtained, such as when the event occurred, the event type, the transaction details, and the transaction validation result. Those details can then be hashed plus the previous record's hash. The hash can be signed by a private key or a public key and then verified by the corresponding key.

The public key may be obfuscated in the code for the transaction validation service.

When the code is packaged and shipped to the third party's server, the code itself would be obfuscated, so that the public key would be difficult to find. The public key can be stored in parts and assembled by the code. In some embodiments, the transaction validation service may call out to a signing service to have the hashed logging record signed, such as a physical key.

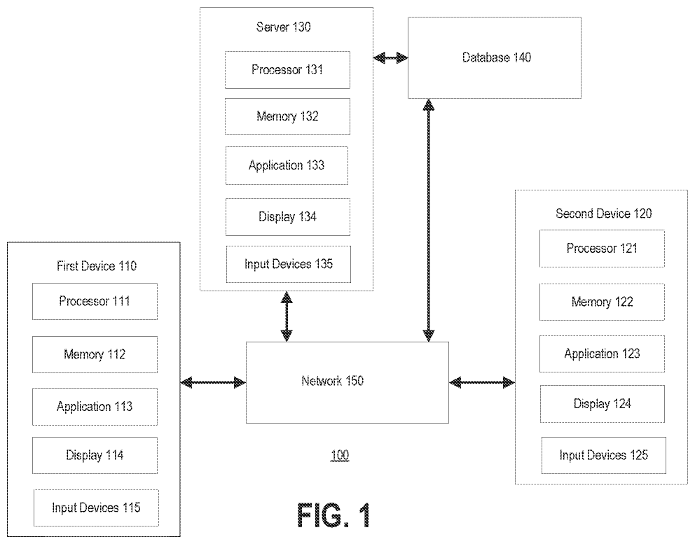

FIG. 1 illustrates a system 100 of transaction validation according to an example embodiment. As further discussed below, the system 100 may include a first device 110, a second device 120, a server 130, and a database 140 in communication using a network 150. Although FIG. 1 illustrates single instances of the components, the system 100 may include any number of components.

The first device 110 may be associated with a financial institution that provides the code or software program of transaction validation.

The first device 110 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The first device 110 may include a processor 111, a memory 112, and an application 113. The processor 111 may be a processor, a microprocessor, or other processor, and the first device 110 may include one or more of these processors. The processor 111 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the first device 110 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 112 may be configured to store one or more software applications, such as the application 113, and other data, such as user's financial account information.

The application 113 may comprise one or more software applications comprising instructions for execution on the first device 110. In some examples, the first device 110 may execute one or more applications, such as software applications, that enable, for example, network communications with one or more components of the system 100, transmit and/or receive data, and perform the functions described herein. Upon execution by the processor 111, the application 113 may provide the functions described in this specification, specifically to execute and perform the steps and functions in the process flows described herein. Such processes may be implemented in software, such as software modules, for execution by computers or other machines. The application 113 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The first device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the first device 110 that is available and supported by the first device 110, such as a touch-screen, keyboard, mouse, cursor-control device, microphone, digital camera, video recorder or camcorder. These devices may be used to enter information and interact with the software and other devices described herein.

The second device 120 can be associated with another financial institution that can issue various payment instruments to users and request transaction validation service performed using the code or software program of transaction validation.

The second device 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The second device 120 may include a processor 121, a memory 122, an application 123, a display 124, and input devices 125. The processor 121 may be a processor, a microprocessor, or other processor, and the second device 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the second device 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as private and personal information.

The application 123 may comprise one or more software applications comprising instructions for execution on the second device 120. In some examples, the second device 120 may execute one or more applications, such as software applications, that enable, for example, network communications with one or more components of the system 100, transmit and/or receive data, and perform the functions described herein. Upon execution by the processor 121, the application 123 may provide the functions described in this specification, specifically to execute and perform the steps and functions in the process flows described herein. Such processes may be implemented in software, such as software modules, for execution by computers or other machines. The application 123 may provide graphic user interfaces (GUIs) through which users may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The second device 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the second device 120 that is available and supported by the second device 120, such as a touch-screen, keyboard, mouse, cursor-control device, microphone, digital camera, video recorder or camcorder. These devices may be used to enter information and interact with the software and other devices described herein such as selecting an option of creating an online account with the merchant.

The server 130 may be associated with a third party who runs the transaction validation service using the code or software program of transaction validation, and can be configured to communicate with the first device 110 and/or the second device 120.

The server 130 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 130 may include a processor 131, a memory 132, and an application 133. The processor 131 may be a processor, a microprocessor, or other processor, and the server 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the server 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's financial account information and the contactless card information.

The application 133 may comprise one or more software applications comprising instructions for execution on the server 130. In some examples, the server 130 may execute one or more applications, such as software applications, that enable, for example, network communications with one or more components of the system 100, transmit and/or receive data, and perform the functions described herein. Upon execution by the processor 131, the application 133 may provide the functions described in this specification, specifically to execute and perform the steps and functions in the process flows described herein. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the server 130 that is available and supported by the server 130, such as a touch-screen, keyboard, mouse, cursor-control device, microphone, digital camera, video recorder or camcorder. These devices may be used to enter information and interact with the software and other devices described herein.

The database 140 may be one or more databases configured to store date, including without limitation, private information of users, financial accounts of users, and transactions of users. The database 140 may comprise a relational database, a non-relational database, or other database implementations, and any combination thereof, including a plurality of relational databases and non-relational databases. In some examples, the database 140 may comprise a desktop database, a mobile database, or an in-memory database. Further, the database 140 may be hosted internally by the server 130 or may be hosted externally of the server 130, such as by a server, by a cloud-based platform, or in any storage device that is in data communication with the server 130.

The system 100 may include one or more networks 150. In some examples, the network 150 may be one or more of a wireless network, a wired network or any combination of wireless network and wired network, and may be configured to connect the first device 110, the second device 120, the server 130, and the database 140. For example, the network 150 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 150 may include, without limitation, telephone lines, fiber optics, IEEE Ethernet 902.3, a wide area network, a wireless personal area network, a LAN, or a global network such as the Internet. In addition, the network 150 may support an Internet network, a wireless communication network, a cellular network, or the like, or any combination thereof. The network 150 may further include one network, or any number of the exemplary types of networks mentioned above, operating as a stand-alone network or in cooperation with each other. The network 150 may utilize one or more protocols of one or more network elements to which they are communicatively coupled. The network 150 may translate to or from other protocols to one or more protocols of network devices. Although the network 150 is depicted as a single network, it should be appreciated that according to one or more examples, the network 150 may comprise a plurality of interconnected networks, such as, for example, the Internet, a service provider's network, a cable television network, corporate networks, such as credit card association networks, and home networks. The network 150 may further comprise, or be configured to create, one or more front channels, which may be publicly accessible and through which communications may be observable, and one or more secured back channels, which may not be publicly accessible and through which communications may not be observable.

In some examples, communications between the first device 110, server 130, and second device 120 using the network 150 can occur using one or more front channels and one or more secure back channels. A front channel may be a communication protocol that employs a publicly accessible and/or unsecured communication channel such that a communication sent to the first device 110, server 130, and/or second device 120 may originate from any other device, whether known or unknown to the first device 110, server 130, and/or second device 120, if that device possesses the address (e.g., network address, Internet Protocol (IP) address) of the first device 110, server 130, and/or second device 120. Exemplary front channels include, without limitation, the Internet, an open network, and other publicly-accessible communication networks. In some examples, communications sent using a front channel may be subject to unauthorized observation by another device. In some examples, front channel communications may comprise Hypertext Transfer Protocol (HTTP) secure socket layer (SSL) communications, HTTP Secure (HTTPS) communications, and browser-based communications with a server or other device.

A secure back channel may be a communication protocol that employs a secured and/or publicly inaccessible communication channel. A secure back channel communication sent to the first device 110, server 130, and/or second device 120 may not originate from any device, and instead may only originate from a selective number of parties. In some examples, the selective number of devices may comprise known, trusted, or otherwise previously authorized devices. Exemplary secure back channels include, without limitation, a closed network, a private network, a virtual private network, an offline private network, and other private communication networks. In some examples, communications sent using a secure back channel may not be subject to unauthorized observation by another device. In some examples, secure back channel communications may comprise Hypertext Transfer Protocol (HTTP) secure socket layer (SSL) communications, HTTP Secure (HTTPS) communications, and browser-based communications with a server or other device.

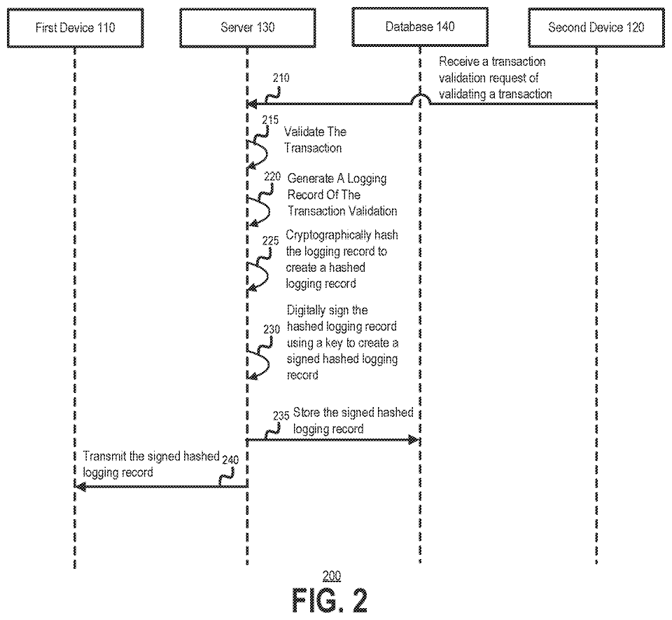

FIG. 2 illustrates an example diagram 200 of sequence interaction between the components of the system 100 according to an example embodiment. FIG. 2 may reference the same or similar components as those illustrated in FIG. 1, including a first device, a server, a database, and a second device.

The financial institution, such as a bank, associated with the second device 120 may issue contactless cards to its customers. The customers may use the contactless cards to conduct various transactions, such as online purchases. When the second device 120 receive a transaction from a customer. The second device 120 may transmit the transaction validation request to the server 130 on which the transaction validation service software program is deployed. Accordingly, at step 210, the server 130 receive a transaction validation request of validating a transaction from the second device 120.

At step 215, the server 130 may validate the transaction. The transaction validation request can include information about a contactless card used for the transaction. The validation can include validating a cryptogram generated by the contactless card when the transaction is being conducted.

At step 220, the server 130 may generate a logging record of the transaction validation. The logging record can include the transaction information, the contactless card information, the issuer of the contactless card, a monotonically increased number indicative of a sequence number of the transaction validation request, a timestamp indicative of a time at which the transaction validation request is being received and processed, and so forth.

At step 225, the server 130 may cryptographically hash the logging record to create a hashed logging record. Various hashing algorithms can be used. For example, the hashing algorithm can be a MD-5 algorithm. The hashing algorithm can be a RACE Integrity Primitives Evaluation Message Digest (RIPEMD-160) algorithm. The hashing algorithm can be a Secure Hash Algorithms (SHA) including SHA-0, SHA-1, SHA-2 and SHA-3. The hashing algorithm can be a Whirlpool algorithm based on the Advanced Encryption Standard.

At step 230, the server 130 may digitally sign the hashed logging record using a key to create a signed hashed logging record. The key can be managed by a hardware security module (HSM) of the server 130 which the client device (e.g., the second device 120) has access to for performing cryptographic functions, but not able to access the keys directly. In an embodiment, the hashed logging record can be signed with a public key embedded and obfuscated in the code of the transaction validation software program.

At step 235, the server 130 may store the signed hashed logging record to the database 140. The server 130 may also store the original logging record (i.e., the logging record prior to be hashed) to the database 140.

At step 240, the server 130 may transmit the signed hashed logging record to the first device 110. The server 130 may also transmit the original logging record (i.e., the logging record prior to be hashed) to the first device 110. The server 130 may further generate and transmit a heartbeat patten message or record to the first device 110.

With the signed hashed logging record, the first device 110 can determine whether the original logging record has been tampered with, so as to bill the correct fee for the transaction validation service provided by the server 130 to the card issuers (e.g., a card issuer associated with the second device 120). Further, with the heartbeat patten record, the first device 110 can determine the running status of the transaction validation service provided by the server 130, for example, whether the transaction validation service has been turned off or disrupted at some point of time.

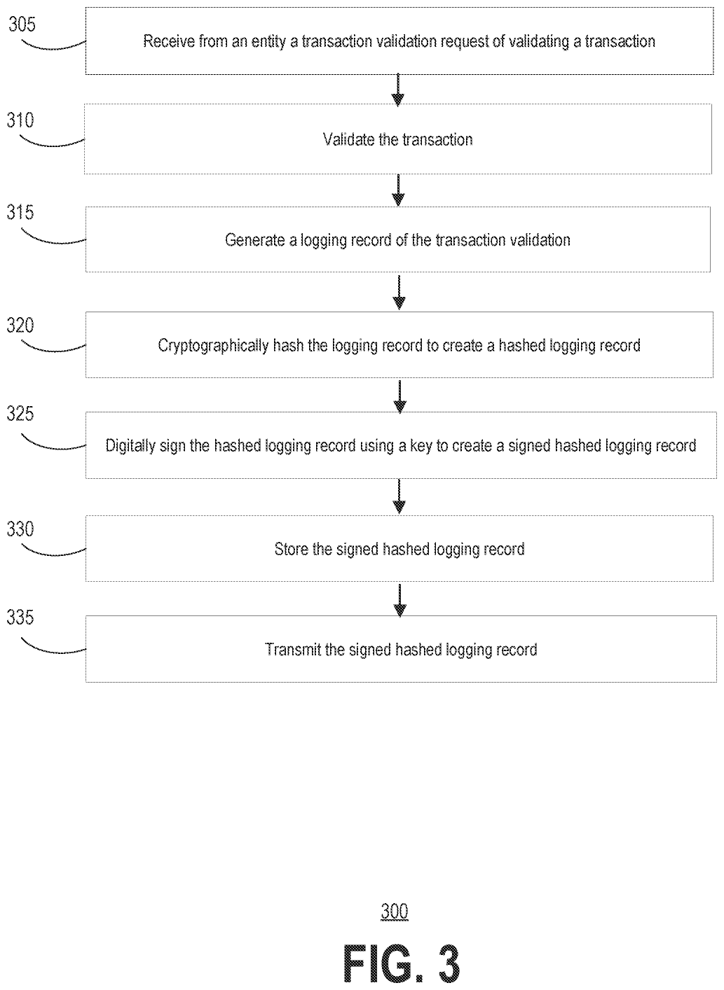

FIG. 3 illustrates a flow chart of an example method 300 of generating transaction validation logging records according to an example embodiment. FIG. 3 may reference the same or similar components as those illustrated in FIGS. 1 and 2, including a first device, a server, a database, and a second device. The method 300 can be implemented in the system 100 and may include, but is not limited to the following steps.

The server 130 may be deployed with the transaction validation service software program for providing transaction validation service for card issuers. At step 305, the server 130 may receive from an entity a transaction validation request of validating a transaction. The entity can be a bank associated with the second device 120. The bank may issue contactless cards to its customers. The customers may use the contactless cards to conduct various transactions, such as online and/or offline shopping. When the second device 120 receive a transaction from a customer using the contactless card. The second device 120 may transmit the transaction validation request to the server 130.

At step 310, the server 130 may validate the transaction. The transaction validation request can include information about the contactless card used for the transaction. The validation can include validating a cryptogram generated by the contactless card when the transaction is being conducted. For example, the server 130 may generate a cryptogram and compare the generated cryptogram with the received cryptogram from the second device 120. The validation can also include validating an unique customer identifier associated with the contactless card.

At step 315, the server 130 may generate a logging record of the transaction validation. The logging record can include the transaction information, the contactless card information, the issuer of the contactless card, a monotonically increased number indicative of a sequence number of the transaction validation request, a timestamp indicative of a time at which the transaction validation request is being received and processed, and so forth.

At step 320, the server 130 may cryptographically hash the logging record to create a hashed logging record. Various hashing algorithms can be used including, but not limited to, MD-5 algorithm, RIPEMD-160 algorithm, SHA, and Whirlpool algorithm.

At step 325, the server 130 may digitally sign the hashed logging record using a key to create a signed hashed logging record. The hash can be signed by a private key or a public key and then verified by the corresponding key. The public key may be obfuscated in the code for the transaction validation service. When the code is packaged and shipped to the server 130, the code itself would be obfuscated, so that the public key would be difficult to find. The public key can be stored in parts and assembled by the code. In some embodiments, the transaction validation service may call out to a signing service to have the hashed logging record signed, such as a physical key.

The key can be managed by a hardware security module (HSM) of the server 130 which the client device (e.g., the second device 120) has access to for performing cryptographic functions, but not able to access the keys directly.

At step 330, the server 130 may store the signed hashed logging record to the database 140. The server 130 may also store the original logging record (i.e., the logging record prior to be hashed) to the database 140. The server 130 may further generate and store a heartbeat patten message or record to the database 140.

At step 335, the server 130 may transmit the signed hashed logging record to the first device 110. The server 130 may also transmit the original logging record (i.e., the logging record prior to be hashed) to the first device 110. The server 130 may further transmit the heartbeat patten message or record to the first device 110.

With the signed hashed logging record, the first device 110 can be allowed to verify that the original logging record is untampered with and that the original logging record is produced by the transaction validation service.

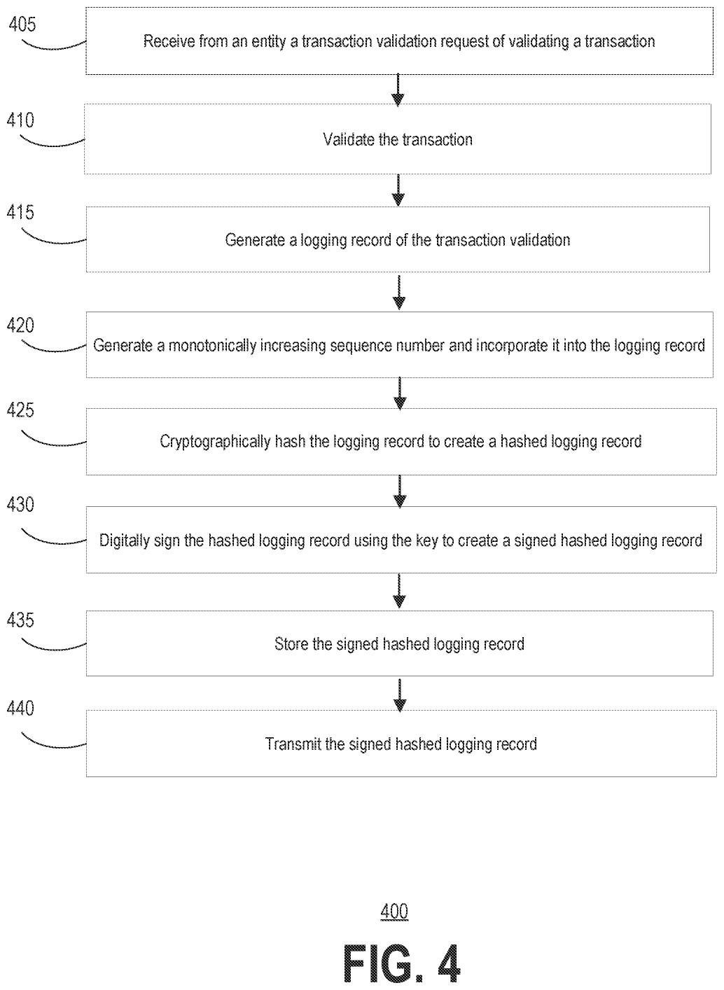

FIG. 4 illustrates a flow chart of an example method 400 of performing transaction validation and generating transaction validation records according to an example embodiment.

FIG. 4 may reference the same or similar components as those illustrated in FIGS. 1-3, including a first device, a server, a database, and a second device. The method 400 can be implemented in the system 100 and may include, but is not limited to the following steps.

A transaction validation service software program may be deployed on the server 130 for providing transaction validation service for card issuers. At step 405, the server 130 may receive from an entity a transaction validation request of validating a transaction. The entity can be a bank associated with the second device 120. The bank may issue contactless cards to its customers. The customers may use the contactless cards to conduct various transactions, such as online and/or offline shopping. When the second device 120 receive a transaction from a customer using the contactless card. The second device 120 may transmit the transaction validation request to the server 130.

At step 410, the server 130 may validate the transaction. The transaction validation request can include information about the contactless card used for the transaction. The validation can include validating a cryptogram generated by the contactless card when the transaction is being conducted. For example, the server 130 may generate a cryptogram and compare the generated cryptogram with the received cryptogram from the second device 120. The validation can also include validating an unique customer identifier associated with the contactless card.

At step 415, the server 130 may generate a logging record of the transaction validation. The logging record can include the transaction information, the contactless card information, the issuer of the contactless card, a monotonically increased number indicative of a sequence number of the transaction validation request, a timestamp indicative of a time at which the transaction validation request is being received and processed, and so forth.

At step 420, the server 130 may generate a monotonically increasing sequence number corresponding to the transaction validation request. The monotonically increasing sequence number can be used to label the sequence of the transaction validation request, such that missing transaction validation requests may be determined. The monotonically increasing sequence number may be a numerical number, such as 123, may be a set of letters such as ABC, may be roman numerals such as I, II, III, or combinations thereof. The server 130 can incorporate it into the logging record.

At step 425, the server 130 may cryptographically hash the logging record including the monotonically increasing sequence number to create a hashed logging record. Various hashing algorithms can be used including, but not limited to, MD-5 algorithm, RIPEMD-160 algorithm, SHA, and Whirlpool algorithm.

At step 430, the server 130 may digitally sign the hashed logging record using a key to create a signed hashed logging record. The hash can be signed by a private key or a public key and then verified by the corresponding key. The public key may be obfuscated in the code for the transaction validation service. When the code is packaged and shipped to the server 130, the code itself would be obfuscated, so that the public key would be difficult to find. The public key can be stored in parts and assembled by the code. In some embodiments, the transaction validation service may call out to a signing service to have the hashed logging record signed, such as a physical key.

The key can be managed by a hardware security module (HSM) of the server 130 which the client device (e.g., the second device 120) has access to for performing cryptographic functions, but not able to access the keys directly.

At step 435, the server 130 may store the signed hashed logging record to the database 140. The server 130 may also store the original logging record (i.e., the logging record prior to be hashed) including the monotonically increasing sequence number to the database 140.

At step 440, the server 130 may transmit the signed hashed logging record to the first device 110. The server 130 may also transmit the original logging record (i.e., the logging record prior to be hashed) including the monotonically increasing sequence number to the first device 110.

With the signed hashed logging record, the first device 110 can be allowed to verify that the original logging record is untampered with and that the original logging record is produced by the transaction validation service.

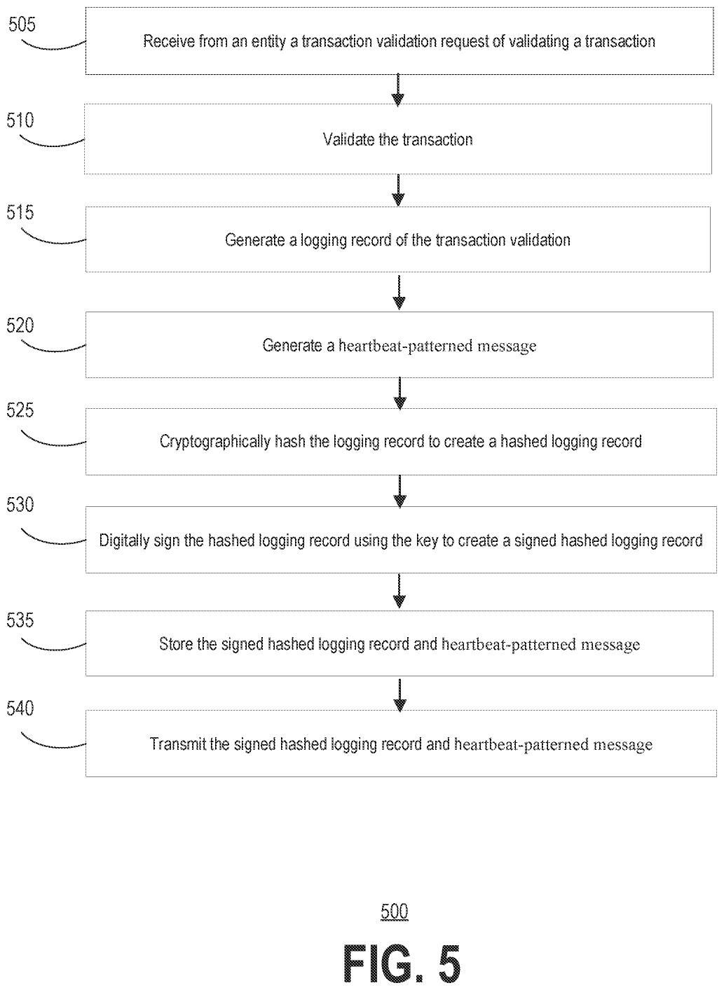

FIG. 5 illustrates a flow chart of an example method 500 of performing transaction validation and generating transaction validation records according to an example embodiment. FIG. 5 may reference the same or similar components as those illustrated in FIGS. 1-4, including a first device, a server, a database, and a second device. The method 500 can be implemented in the system 100 and may include, but is not limited to the following steps.

The transaction validation service may need to be monitored to ensure its proper operation. A heartbeat pattern record can be used to detect the anomaly of the transaction validation service. At a regular interval, a heartbeat pattern record would be produced whether or not any transaction validation had occurred. This can allow monitoring for the up time of the transaction validation service, in addition to how many transaction validations had occurred. For example, if transaction validations are redirected or the transaction validation service is turned off, that can be detected by looking at the frequency of these heartbeat pattern record. If there have an anomaly or a gap in the heartbeat records, and they are not at the regular interval, then the transaction validation service can be detected to have been down for some time. The heartbeat records are non-transactional heartbeat records that can be a part of the immutable hash-tree record. This way it can detect if transaction validations were just skipped, or if the server 130 on which the transaction validation service is deployed is continuously active. This heartbeat record can also include a monotonically increasing counter plus a timecode. This heartbeat record can be a record that is intrinsic to the transaction validation system itself (i.e., the server 130) and is not tied to a specific transaction and contains a timestamp. The heartbeat record occurs at a regular interval. The regular interval can be defined inside the heartbeat record itself or it can be something that is understood externally and implicit in the heartbeat record. For example, the interval can be operationally significant time frames, such as short enough to not represent a significant loss of traffic and long enough to not produce too much data.

At step 505, the server 130 may receive from an entity a transaction validation request of validating a transaction. The entity can be a bank associated with the second device 120. The bank may issue contactless cards to its customers. The customers may use the contactless cards to conduct various transactions, such as online and/or offline shopping. When the second device 120 receive a transaction from a customer using the contactless card. The second device 120 may transmit the transaction validation request to the server 130.

At step 510, the server 130 may validate the transaction. The transaction validation request can include information about the contactless card used for the transaction. The validation can include validating a cryptogram generated by the contactless card when the transaction is being conducted. For example, the server 130 may generate a cryptogram and compare the generated cryptogram with the received cryptogram from the second device 120. The validation can also include validating an unique customer identifier associated with the contactless card.

At step 515, the server 130 may generate a logging record of the transaction validation. The logging record can include the transaction information, the contactless card information, the issuer of the contactless card, a monotonically increased number indicative of a sequence number of the transaction validation request, a timestamp indicative of a time at which the transaction validation request is being received and processed, and so forth.

At step 520, the server 130 can generate a heartbeat pattern record indicative of the operation status of the server 130.

At step 525, the server 130 may cryptographically hash the logging record and/or the heartbeat pattern record to create a hashed logging record. Various hashing algorithms can be used including, but not limited to, MD-5 algorithm, RIPEMD-160 algorithm, SHA, and Whirlpool algorithm. In some embodiments, the server 130 may only cryptographically hash the logging record but not the heartbeat pattern record to create a hashed logging record.

At step 530, the server 130 may digitally sign the hashed logging record using a key to create a signed hashed logging record. The hash can be signed by a private key or a public key and then verified by the corresponding key. The public key may be obfuscated in the code for the transaction validation service. When the code is packaged and shipped to the server 130, the code itself would be obfuscated, so that the public key would be difficult to find. The public key can be stored in parts and assembled by the code. In some embodiments, the transaction validation service may call out to a signing service to have the hashed logging record signed, such as a physical key.

The key can be managed by a hardware security module (HSM) of the server 130 which the client device (e.g., the second device 120) has access to for performing cryptographic functions, but not able to access the keys directly.

At step 535, the server 130 may store the signed hashed logging record to the database 140. The server 130 may also store the original logging record (i.e., the logging record prior to be hashed) to the database 140. The server 130 may further store the heartbeat pattern record to the database 140.

At step 540, the server 130 may transmit the signed hashed logging record to the first device 110. The server 130 may also transmit the heartbeat pattern record to the first device 110.

The logging record can include a particular action or event that was called on the server 130 of the transaction validation service. It can include an event identification (ID), the type of event that happened, and any kind of metadata with that event. The event ID may indicate what type of event occurred, for example, a key validation has occurred. There may have metadata that is associated with that event, which can provide details about that event. Those details can include the details of the transaction itself. The metadata may also include which card issuer is using the transaction validation service.

In some embodiment, the event ID can be a snowflake ID. The snowflake ID is a way to generate a unique ID that is full ordered from a timestamp point but unique enough. That snowflake ID is generated by parallel systems that are not duplicated. Through the timestamp, event details can be obtained, such as when the event occurred, the event type, the transaction details, and the transaction validation result. Those details can then be hashed plus the previous record's hash. The hash can be signed by a private key or a public key and then verified by the corresponding key.

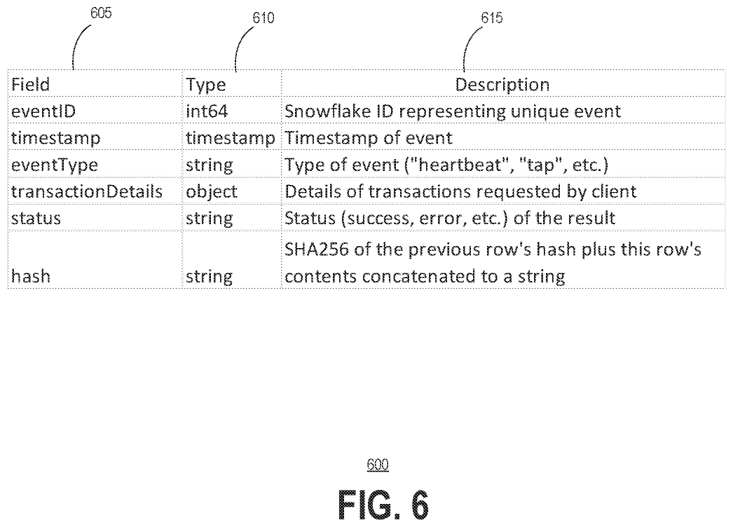

FIG. 6 illustrates a diagram showing an exemplary logging record. As shown in FIG. 6, a logging record may include a ‘field’ column 605, a ‘type’ column 610, and a ‘description’ column 615. The ‘filed’ column 605 can include fields: ‘event ID,’ ‘timestamp,’ ‘eventType,’ ‘transactionDetails,’ ‘status,’ and ‘hash’. The ‘type’ column 610 can include: ‘int64’ that describes the type of the ‘eventID,’ ‘timestamp’ that describes the type of the ‘timestamp,’ ‘string’ that describes the type of the ‘eventType,’ ‘object’ that describes the type of the ‘transactionDetails,’ ‘string’ that describes the type of the ‘status,’ and ‘string’ that describes the type of the ‘hash’. The ‘description’ column 610 can provide details about the items listed in the ‘field’ column 605. For example, the ‘description’ corresponding to the ‘hash’ can provide details about the ‘hash’: SHA256 of the previous row's (record's) hash plus this row's (record's) contents concatenated to a string.

In some aspects, the techniques described herein relate to a system of validating transactions, including a server including a memory and a processor, wherein the server is configured to: receive from an entity a transaction validation request of validating a transaction; validate the transaction; generate a logging record of the transaction validation; cryptographically hash the logging record to create a hashed logging record; digitally sign the hashed logging record using a key to create a signed hashed logging record; and transmit the signed hashed logging record to a computer device.

In some aspects, the techniques described herein relate to a system, wherein the key is a public key or a private key.

In some aspects, the techniques described herein relate to a system, wherein the public key is obfuscated.

In some aspects, the techniques described herein relate to a system, wherein the key is managed by a hardware security module of the server.

In some aspects, the techniques described herein relate to a system, wherein the entity digitally signs the hashed logging record using the key by accessing to the server.

In some aspects, the techniques described herein relate to a system, wherein the logging record includes a monotonically increasing sequence number.

In some aspects, the techniques described herein relate to a system, wherein the logging record includes a hash of hashes of previous logging records.

In some aspects, the techniques described herein relate to a system, wherein the signed hashed logging record is transmitted to the computer device in real time.

In some aspects, the techniques described herein relate to a method of validating transactions performed by a server, including: receiving from an entity a transaction validation request of validating a transaction; validating the transaction; generating a logging record of the transaction validation; cryptographically hashing the logging record to create a hashed logging record; digitally signing the hashed logging record using a key to create a signed hashed logging record; and transmitting the signed hashed logging record to a computer device.

In some aspects, the techniques described herein relate to a method, wherein the signed hashed logging record is transmitted to the computer device in batch.

In some aspects, the techniques described herein relate to a method, wherein the signed hashed logging record is transmitted to the computer device through file logging service.

In some aspects, the techniques described herein relate to a method, wherein the signed hashed logging record is transmitted to the computer device through a messaging service.

In some aspects, the techniques described herein relate to a method, wherein the server is further configured to generate a heartbeat-patterned message to monitor runtime of the server.

In some aspects, the techniques described herein relate to a method, wherein the heartbeat-patterned message includes timestamps indicating a time interval.

In some aspects, the techniques described herein relate to a method, wherein the logging record includes an event identity, event type information, a timestamp, and event details.

In some aspects, the techniques described herein relate to a non-transitory, computer-readable medium including instructions for validating transactions that, when executed on a computer arrangement, cause the computer arrangement to perform actions including: receiving from an entity a transaction validation request of validating a transaction; validating the transaction; generating a logging record of the transaction validation; cryptographically hashing the logging record to create a hashed logging record; digitally signing the hashed logging record using a key to create a signed hashed logging record; and transmitting the signed hashed logging record to a computer device.

In some aspects, the techniques described herein relate to a non-transitory, computer-readable medium, wherein the key is managed by a hardware security module of the server.

In some aspects, the techniques described herein relate to a non-transitory, computer-readable medium, wherein the logging record includes an event identity, event type information, a timestamp, and event details.

In some aspects, the techniques described herein relate to a non-transitory, computer-readable medium, wherein the logging record includes a hash of hashes of previous logging records.

In some aspects, the techniques described herein relate to a non-transitory, computer-readable medium, wherein the server is further configured to generate a heartbeat-patterned message to monitor runtime of the server.

As used herein, the term “transaction” can include, without limitation, financial transactions. However, it is understood that the term “transaction” is not limited thereto, and the present disclosure can include financial transactions, identity verification transactions, area access transactions, user authentication transactions, membership verification transactions, eligibility verification transactions, and any other operation involving a card.

In some examples, the present disclosure refers to a transaction involving a merchant or vendor, which may include, without limitation, retail merchants and vendors. However, it is understood that the term “merchant” is not limited thereto, and the present disclosure can include any type of merchant, vendor, or other entity involving in activities where products or services are sold or otherwise provided, either online, in a physical location, or both.

As used herein, the terms “entity” and “institution” can include, without limitation, financial institutions (e.g., a bank). However, it is understood that the terms “entity” and “institution” are not limited thereto, and the present disclosure can include individuals, corporations, state, local, and federal governments, and any other entity involved in transactions.

In some examples, exemplary procedures in accordance with the present disclosure described herein can be performed by a processing arrangement and/or a computer arrangement (e.g., a computer hardware arrangement). Such processing and/or computer arrangement can be, for example entirely or a part of, or include, but not limited to, a computer/processor that can include, for example one or more microprocessors, and use instructions stored on a computer-accessible medium (e.g., RAM, ROM, hard drive, or other storage device). For example, a computer-accessible medium can be part of the memory of a first device, a user device, a server, or other computer hardware arrangement. The computer arrangement herein can be the first device 110, the second device 120, and/or the server 130 in the system 100 of FIG. 1.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, and any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

Throughout the disclosure, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system of validating transactions, comprising a server including a memory and a processor, wherein the server is configured to:
receive from an entity a transaction validation request of validating a transaction;
validate the transaction;
generate a logging record of the transaction validation;
cryptographically hash the logging record to create a hashed logging record;
digitally sign the hashed logging record using a key to create a signed hashed logging record; and
transmit the signed hashed logging record to a computer device.

2. The system according to claim 1, wherein the key is a public key or a private key.

3. The system according to claim 2, wherein the public key is obfuscated.

4. The system according to claim 1, wherein the key is managed by a hardware security module of the server.

5. The system according to claim 1, wherein the entity digitally signs the hashed logging record using the key by accessing to the server.

6. The system according to claim 1, wherein the logging record comprises a monotonically increasing sequence number.

7. The system according to claim 1, wherein the logging record comprises a hash of hashes of previous logging records.

8. The system according to claim 1, wherein the signed hashed logging record is transmitted to the computer device in real time.

9. A method of validating transactions performed by a server, comprising:
receiving from an entity a transaction validation request of validating a transaction;
validating the transaction;
generating a logging record of the transaction validation;
cryptographically hashing the logging record to create a hashed logging record;
digitally signing the hashed logging record using a key to create a signed hashed logging record; and
transmitting the signed hashed logging record to a computer device.

10. The method according to claim 9, wherein the signed hashed logging record is transmitted to the computer device in batch.

11. The method according to claim 9, wherein the signed hashed logging record is transmitted to the computer device through file logging service.

12. The method according to claim 9, wherein the signed hashed logging record is transmitted to the computer device through a messaging service.

13. The method according to claim 9, wherein the server is further configured to generate a heartbeat-patterned message to monitor runtime of the server.

14. The method according to claim 13, wherein the heartbeat-patterned message comprises timestamps indicating a time interval.

15. The method according to claim 9, wherein the logging record comprises an event identity, event type information, a timestamp, and event details.

16. A non-transitory, computer-readable medium comprising instructions for validating transactions that, when executed on a computer arrangement, cause the computer arrangement to perform actions comprising:
receiving from an entity a transaction validation request of validating a transaction;
validating the transaction;
generating a logging record of the transaction validation;
cryptographically hashing the logging record to create a hashed logging record;
digitally signing the hashed logging record using a key to create a signed hashed logging record; and
transmitting the signed hashed logging record to a computer device.

17. The non-transitory, computer-readable medium according to claim 16, wherein the key is managed by a hardware security module.

18. The non-transitory, computer-readable medium according to claim 16, wherein the logging record comprises an event identity, event type information, a timestamp, and event details.

19. The non-transitory, computer-readable medium according to claim 16, wherein the logging record comprises a hash of hashes of previous logging records.

20. The non-transitory, computer-readable medium according to claim 16, wherein the actions further comprises generating a heartbeat-patterned message.
